(19) United States
(12) Patent Application Publication
(10) Pub. No.: US 2023/0224510 A1
(43) Pub. Date: Jul. 13, 2023

(54) Apparats, Method, and System Utilizing USB or Wireless Cameras and Online Network for Force-on-Force Training Where the Participants Can Be In the Same Room, Different Rooms, or Different Geographic Locations

(71) Applicant: Andrey Safanyuk, Langhorne, PA (US)

(72) Inventor: Andrey Safanyuk, Langhorne, PA (US)

(21) Appl. No.: 17/978,171

(22) Filed: Oct. 31, 2022

Related U.S. Application Data
(60) Provisional application No. 63/273,959, filed on Oct. 31, 2021.

(51) Int. Cl. H04N 21/2187; H04N 5/74; H04N 5/272; F41A 33/00

(52) U.S. Cl. CPC H04N 21/2187; H04N 5/74; H04N 5/272; F41A 33/00

(57) ABSTRACT

Apparatus, method, and system utilizing USB or wireless cameras and online network for force-on-force training where live participants can be in the same room, different rooms, or different geographic locations. A video camera is aimed at a live actor and the computer, via a projector and software program, transfers it to a wall or projection screen. The live actor can choose a picture or video as a background and virtually transfer the action to a different environment. The live role model can be in the same room or connected via the internet to provide a live, non-recorded interactive training experience. The computer, when projecting the live video, adds a series of dots to the live video signal received that is being transferred to the wall or projection screen by the projector. A sensor camera detects the projected dots and saves their positions relative to the camera frame for later use.

### FEDERALLY SPONSORED RESEARCH: Not Applicable

### SEQUENCE LISTING OR PROGRAM: Not Applicable

### TECHNICAL FIELD OF THE INVENTION

The present invention relates to interactive firearms training for civilians and law enforcement. More particularly, the invention relates to interactive firearm training for escalation and/or de-escalation of armed situations for inactive law enforcement, active military, self-defense training, or in an educational facility which provides a live actor.

### BACKGROUND OF THE INVENTION

The idea behind using simulators in training is to make the scenarios as real as possible so instructors can observe, grade, and correct trainees' reactions. If training scenarios can approximate the stress of the street, they are good predictors of how an officer will respond under pressure. The scenarios evaluate not just officers' physical skills, for example marksmanship, but their decision-making skills and their ability to de-escalate the situation. Officers who respond well to the training learn as much about themselves and their limits as they learn about tactics and procedures. These training systems cost from $25,000 to $125,000, depending on the kind of simulator—live fire or laser, fire-back or not, etc. Smaller departments are pooling resources to buy a trainer and then sharing time in the system. Use-of-force training and evaluation simulators will continue to become more sophisticated, easy to use, and worthwhile as a tool for law enforcement, contributing to the goal of better prepared and more effective officers.

While there are many interactive and virtual reality training simulators on the market today such as LASERSHOT, SHOOTOFF, and MEGGIT, these prior art devices utilize the concept of prerecorded videos or games and are unable to provide a live actor or live and realistic engagement of two or more participants.

Virtual Reality (VR) is different as it has to have a presetting for the environment and has to have goggles, which increases the difficulty of use in a group setting as well as costs.

Therefore, what is needed is a live, interactive firearms training solution that uses live interactions, between live people, in place of recordings and is enabled not by expensive and complex VR technology, but simply cameras, computers, and projectors.

### SUMMARY OF THE INVENTION

The present invention teaches an apparatus, method, and system utilizing USB or wireless cameras and online network for force-on-force training where the live participants can be in the Same room, different rooms, or different geographic locations.

The present invention replaces expensive VR technology by utilizing USB or wireless cameras and online networks. Compared to prior art devices, the present invention is quite easy to set up. Any computer platform or basic hardware devices can be used. Physical minimum requirements to enable the present invention are a computer, projector, screen calibration software, camera, and a web camera, or similar.

The background behind the live participants/actors may not require green or blue screens. The background used for each participant can be natural (current) or any video or images can be used to create a different background behind the participant for better or more accurate scenario visual representations.

The method taught by the present invention can be used for live force-on-force training with a group or one on one in a dual situation. This method can be used for civilian educational interactive purposes (online classes and similar).

The live participants can be in the same room, different rooms, or different geographic locations practice of the present invention. The present invention can be used for training purposes for escalation and de-escalation or armed interactions between two or more individuals and is directed to training inactive law enforcement, active military, self-defense training, or in an educational facility.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is an illustration of existing systems in use by competitors in the prior art.

FIG. 2 is an illustration of the present invention with the additional elements in view of the exemplary prior art device of FIG. 1.

FIG. 3 is an illustration of the present invention where two or more live participants are located in the same room.

FIG. 4 is an illustration of the present invention where two or more live participants are located in different rooms.

FIG. 5 is an illustration of the present invention focusing on the projection of the computer screen to a wall or similar surface.

FIG. 6 illustrates the camera frame and dots as taught and projected by the present invention.

FIG. 7 illustrates the camera frame and sensor camera for detecting the laser point or live fire relative to the camera frame.

FIG. 8 illustrates how software uses projected dot and laser point or live fire positions to calculate mouse position on the computer screen to produce a mouse click.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized, and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

The device of the present invention is an apparatus, method, and system utilizing USB or wireless cameras and online network for force-on-force training where the live participants can be in the same room, different rooms, or different geographic locations.

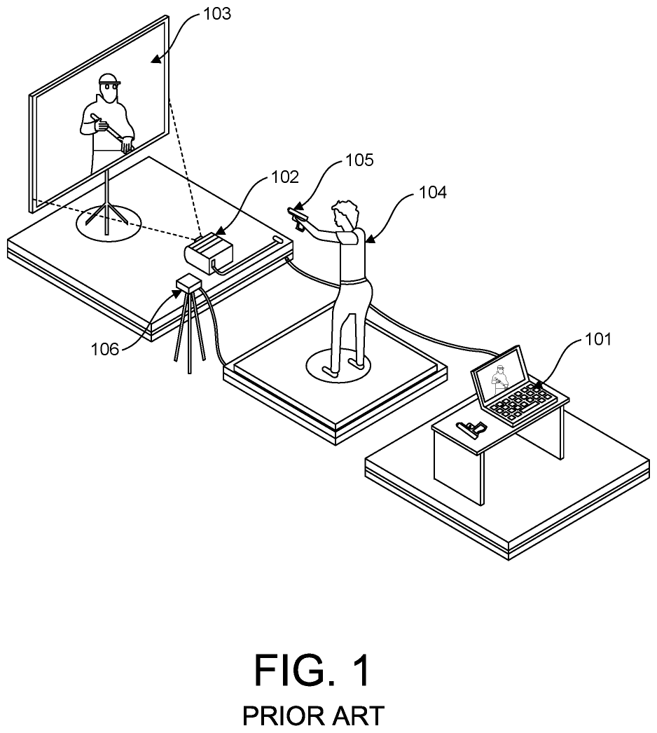

FIG. 1 is an illustration of existing systems in use by competitors in the prior art. Existing systems known in the prior art all use the same concept of prerecorded videos or games to present the simulation or visual presentation for training. In the prior art, a computer 101 generates or plays the video, using a projector 102 and projection screen 103 placed in front of a live participant 104 who is provided a laser gun or live firearm 105. The computer 101 reads information from a sensor camera 106 located adjacent to the live participant 104 and facing the projection screen 103 which provides a screen calibration for determining the shot placement and to show the placement of a shot.

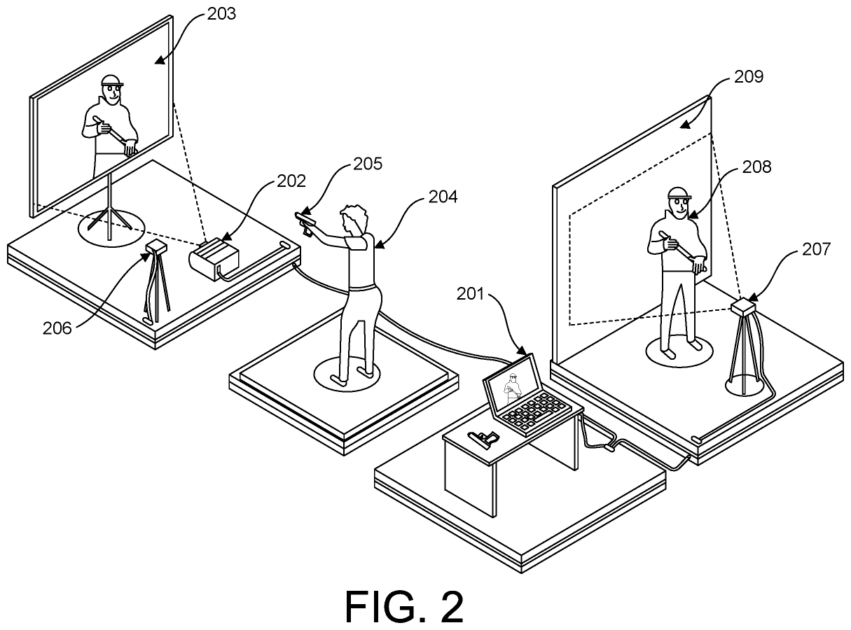

FIG. 2 is an illustration of the present invention with the additional elements in view of the exemplary prior art device of FIG. 1. In this embodiment, a computer 201 still sends video to a projector 202 for display on a projection screen 203 located in front of a live participant 204 provided with a laser or real gun 205.

A sensor camera 206 is still utilized to calibrate the screen 203 and determining the shot placement and to show the placement of a shot. The sensor camera 206 can catch or recognize the shot placement of the laser gun 205 or any real bullets from a live firearm, or any projectile launched toward the projection screen 203.

In the present invention, unlike the prior art, a video camera 207 is aimed at a live role model or live actor 208 and the computer 201, via a projector 202 and software program transfers it to a wall or projection screen 203. The live role model or live actor 208 can choose a picture or video as a background and virtually transfer the action to a different environment. The live role model 208 can be in the same room or connected via the internet (like SKYPE, ZOOM, etc.) to provide a live and non-recorded interactive training experience.

In the embodiment taught by the present invention in FIG. 2, a computer 201 generates video, not from a recording, but from a received live input from a video camera or other live video feed 207 such as that from a video service such as SKYPE, ZOOM, etc. In this example, a video camera 207 records a second live participant, or “live actor” 208 standing or located in front of the video camera 207.

The background 209 may not require green or blue screens. The background 209 used for each live participant 208 can be natural (current) or any video or images can be used to create a different background behind the participant 208 for better or more accurate scenario visual representations resulting in the use of any background in the environment.

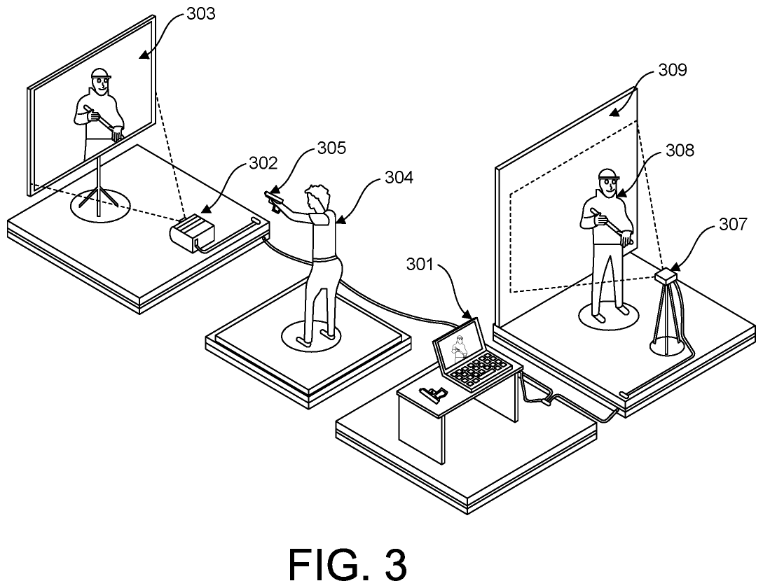

FIG. 3 is an illustration of the present invention where participants 304 and 308 are located in the same room. In the same room embodiment of the present invention, the computer 301 receives a live video signal from a video camera 307 of a live participant/actor 308 located in front of a screen or any background 309 who is being recorded by the video camera 307. The computer 301 then sends the received live video signal to the projector 302 and projects it on a projection screen 303 in front of a participant 304 who is holding a laser gun or live firearm 305 and can have a live interaction with the live participant/actor 308 to simulate a situation.

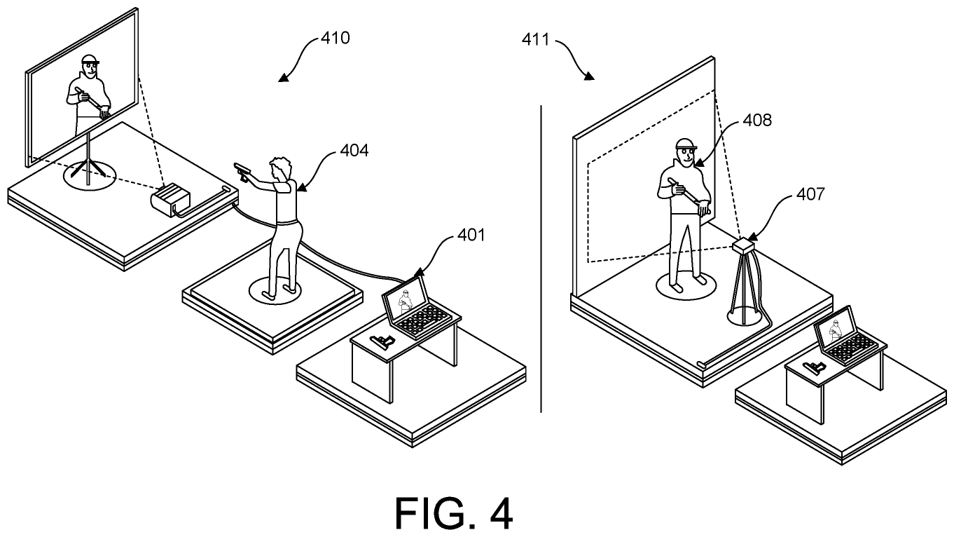

FIG. 4 is an illustration of the present invention where participants 404 and 408 are located in different rooms or in different locations 410 and 411. In this embodiment, the computer 401 receives the video from a camera 407 recording a live participant/actor 408 located in another room or another geographical location 411. The computer 401 can accept the video with a hard wired connection if the live actor 408 is located in a local or adjacent room, or it can receive a wireless video signal such as WIFI or BLUETOOTH either from a local camera or from an online source such as SKYPE or ZOOM. In this embodiment, the participant and live actor 408 need not be located in the same room or even in the same geographical location 410 for a live training interaction to occur as taught by the present invention.

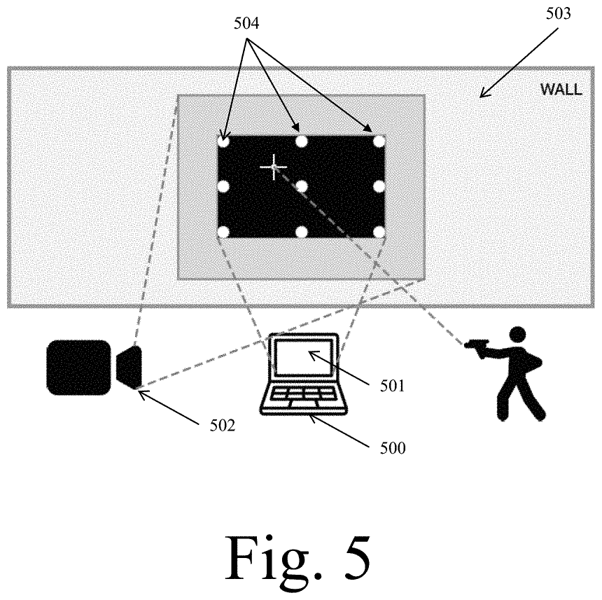

FIG. 5 is an illustration of the present invention focusing on the projection of the computer screen 501 to a wall or similar surface 503. Here the computer screen 501 is projected onto the wall 503 by a projector 502 receiving the video signal from the computer. The computer 500 adds a series of dots 504 to the live video signal received that is being transferred to the wall or projection screen 503 by the projector 502.

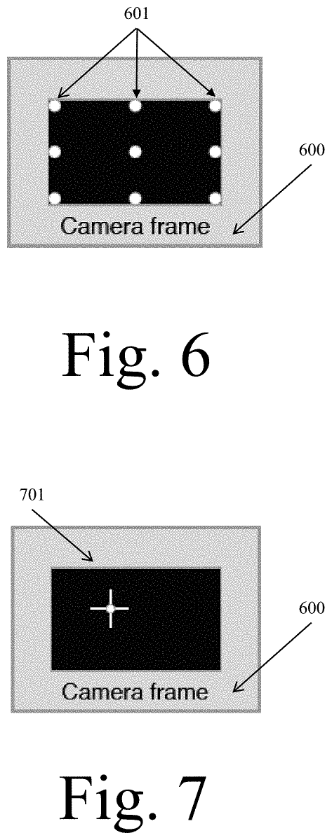

FIG. 6 illustrates the camera frame 600 and dots 601 as taught and projected by the present invention. Here, a sensor camera and sensor camera software detects the projected dots 601 and saves their positions relative to the camera frame 600 for later use.

FIG. 7 illustrates the camera frame 600 and sensor camera for detecting the laser point or live fire 701 relative to the camera frame 600.

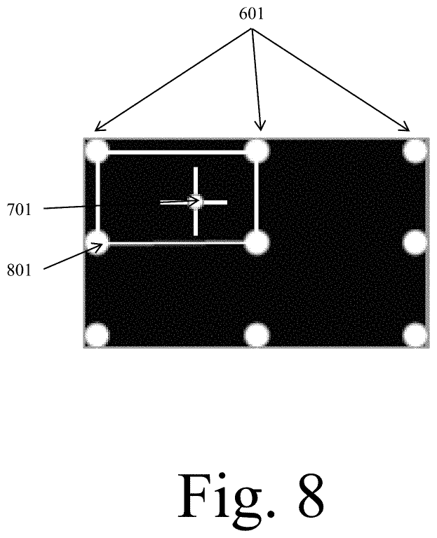

FIG. 8 illustrates how software uses the projected dots 601 and laser point or live fire positions 701 to calculate mouse position on the computer screen to produce a mouse click. As illustrated, the location of a laser point or live fire position or shot 701 is located within a square of four projected dots 801. Sensor Camera software uses the projected dots 601 positions and the laser point or live shot position 701 to calculate and display a mouse position on the computer screen to produce a mouse click representing a shot from the laser gun or real firearm by a participant.

The present invention replaces expensive VR technology by utilizing USB or wireless cameras and online networks. Compared to prior art devices, the present invention is quite easy to set up. Any computer platform or basic hardware devices can be used. Physical minimum requirements to enable the present invention are a computer, projector, screen calibration software, camera, and a web camera, or similar. The sensor camera can catch or recognize the shot placement of the laser gun or any real bullets from a live firearm, or any projectile launched toward the projection screen.

The live participants and live actors can be in the same room, different rooms, or different geographic locations practice of the present invention. The present invention can be used for training purposes for escalation and de-escalation or armed interactions between two or more individuals and is directed to training inactive law enforcement, active military, self-defense training, or in an educational facility.

The method taught by the present invention can be used for force-on-force training with a group or one on one in a dual situation. This method can be used for civilian educational interactive purposes (online classes and similar).

The apparatus, system, and method of the present invention replaces expensive VR technology by utilizing USB or wireless cameras and online networks. The present invention is also quite easy to set up as any computer platform or video hardware or display can be used.

Minimum physical requirements for the present invention are a computer, a projector, screen calibration software, a camera, and the web camera, or similar.

The participants can be in the same room, different rooms, or different geographic locations. The apparatus, system, and method of the present invention can be used for training purposes for escalation and/or de-escalation by inactive law enforcement, active military, self-defense training, or in the educational facility.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A system for incorporating live images for force-on-force training where the live participants can be in the same room, different rooms, or different geographic locations, the system comprising:
a video camera recording a live actor;
a computer receiving a live video recording;
the computer providing a live video feed to a projector;
the projector projecting live video onto a projection screen or wall;
the projector screen or wall placed or located in front of a live participant;
a laser gun or real firearm provided to the participant;
a sensor camera located adjacent to the live participant and facing the projection screen which provides a screen calibration for use by the computer in determining the shot placement and to show the placement of a shot.

2. The system of claim 1, wherein
the video camera is aimed at a live role model or live actor; and
the computer, via a projector and software program transfers it to a wall or projection screen.

3. The system of claim 2, wherein
the live role model or live actor can choose a picture or video as a background and virtually transfer the action to a different environment.

4. The system of claim 2, wherein
the live role model can be in the same room or connected via the internet to provide a live and non-recorded interactive training experience.

5. The system of claim 2, wherein
the computer generates video, not from a recording, but from a received live input from a video camera or other live video feed such as that from a video service; and
the video camera records a second live participant, or “live actor” standing or located in front of the video camera.

6. The system of claim 2, wherein
the background may not require green or blue screens.

7. The system of claim 2, wherein
the background used for each live participant can be natural (current) or any video or images can be used to create a different background behind the participant for better or more accurate scenario visual representations resulting in the use of any background in the environment.

8. The system of claim 2, wherein in the same room embodiment of the present invention,
the computer receives a live video signal from a video camera of a live participant/actor located in front of a screen or any background who is being recorded by the video camera; and
the computer then sends the received live video signal to the projector and projects it on a projection screen in front of a participant who is holding a laser gun or real firearm and can have a live interaction with the live participant/actor to simulate a situation.

9. The system of claim 2, wherein where participants are located in different rooms or in separate locations,
the computer receives the video from a camera recording a live participant/actor located in another room of another geographical location;
the computer can accept the video with a hard wired connection if the live actor is located in a local or adjacent room, or it can receive a USB or wireless video signal either from a local camera or from an online source.

10. The system of claim 2, wherein
the computer screen is projected onto the wall by a projector receiving the video signal from the computer; and
the computer adds a series of dots to the live video signal received that is being transferred to the wall or projection screen by the projector.

11. The system of claim 10, wherein
the sensor camera and sensor camera software detects the projected dots and saves their positions relative to the camera frame for later use.

12. The system of claim 11, wherein
the camera frame and sensor camera for detecting the laser point or live shot relative to the camera frame.

13. The system of claim 12, wherein
software uses the projected dots and laser point or live fire positions to calculate mouse position on the computer screen to produce a mouse click;
the location of a laser point or live fire position or shot is located within a square of four projected dots; and
sensor camera software uses the projected dots positions and the laser point or live fire position to calculate and display a mouse position on the computer screen to produce a mouse click representing a shot from the laser gun or real firearm by a participant.

14. An apparatus for incorporating live images for force-on-force training where the live participants can be in the same room, different rooms, or different geographic locations, the apparatus comprising:
a video camera recording a live actor;
a computer receiving a live video recording;
the computer providing a live video feed to a projector;
the projector projecting live video onto the projection screen or wall;
the projector screen or wall placed or located in front of a live participant;
a laser gun or live firearm provided to the participant;
a sensor camera located adjacent to the live participant and facing the projection screen which provides a screen calibration for use by the computer in determining the shot placement and to show the placement of a shot.

15. The apparatus of claim 14, wherein
the sensor camera can catch or recognize the shot placement of the laser gun or any real bullets from a live firearm, or any projectile launched toward the projection screen.

16. The system of claim 15, wherein
the computer screen is projected onto the wall by a projector receiving the video signal from the computer; and
the computer adds a series of dots to the live video signal received that is being transferred to the wall or projection screen by the projector.

17. The system of claim 16, wherein
the sensor camera and sensor camera software detects the projected dots and saves their positions relative to the camera frame for later use.

18. The system of claim 17, wherein
the camera frame and sensor camera for detecting the laser point or live shot relative to the camera frame.

19. The system of claim 18, wherein
software uses the projected dots and laser point or live fire positions to calculate mouse position on the computer screen to produce a mouse click;
the location of a laser point or live fire position or shot is located within a square of four projected dots; and
sensor camera software uses the projected dots positions and the laser point or live fire position to calculate and display a mouse position on the computer screen to produce a mouse click representing a shot from the laser gun or real firearm by a participant.
